(19) United States
(12) Patent Application Publication
(10) Pub. No.: US 2008/0165098 A1
(43) Pub. Date: Jul. 10, 2008

(54) DRIVING ARCHITECTURE OF LIQUID CRYSTAL DISPLAY

(75) Inventors: Chih-hsiang Yang, Hsin-Chu City (TW); Sheng-kai Hsu, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu City (TW)

(21) Appl. No.: 11/768,124

(22) Filed: Jun. 25, 2007

(30) Foreign Application Priority Data
Jan. 5, 2007 (TW) 096100556

(51) Int. Cl. G09G 3/36

(52) U.S. Cl. 345/87

(57) ABSTRACT

A driving circuit architecture of a liquid crystal display (LCD) is described. The driving circuit comprises a control circuit, a gate driving module and a data driving module. The control circuit generates a gate control signal and a data control signal. The gate driving circuit electrically coupled to the control circuit generates scanning signal according to the gate control signals. The data driving module electrically coupled to the control circuit is used to generate data driving signal according to data control signal. The data driving module comprises a plurality of different type of driving circuits.

### FIELD OF THE INVENTION

The present invention generally relates to a driving architecture, and more particularly, to a driving architecture for a liquid crystal display (LCD).

### BACKGROUND OF THE INVENTION

FIG. 1 is a schematic diagram of a conventional driving architecture of an LCD, wherein a source driver having bi-directional switch is used in the driving architecture. The driving architecture includes a printed circuit board (PCB) 100, printed circuit 102 and source drivers 104 having bi-directional switch on the display board 106. The PCB 100 transmits the display signal to the source drivers on the left region of the display board 106. Similarly, PCB 100 transmits the display signal to the source drivers on the right region of the display board 106 for controlling the display procedure of the display board 106.

Because the source drivers 104 on the left region and the right region of the display board 106 are of the same type, the display signals are adapted to be transmitted in two directions, i.e. the left and the right directions. Thus, it is necessary to switch the source drivers 104 by using switch components to determine whether the display signal is transmitted toward the left or the right directions. That is, the low switch signal and the high level switch signal are used to switch the switch components. Conventionally, the switch functions of the switch components are integrated into a control circuit to control the switch operation of the switch components. Furthermore, a transmission/receiving circuit including two sets of transmission ports and receiving ports should be prepared for source drivers 104 therebetween so that one source driver 104 is capable of transmitting/receiving the display signal from the adjacent source drivers 104 therefrom.

According to the above-mentioned description, additional switch components, control circuit, and transmission/receiving circuit between the source drivers 104 are required, thereby decreasing the transmission speed of the display signal and downgrade the electrical characteristics of the circuit. Moreover, due to the above circuit hardware, area of the driving architecture is considerably enlarged, resulting in high manufacturing cost.

Consequently, there is a need to develop a novel driving architecture to improve the electrical characteristics of the circuit and decrease the manufacturing cost of the LCD.

### SUMMARY OF THE INVENTION

One object of the present invention is to provide a driving architecture for LCD, wherein a plurality of driving devices are disposed on the substrate of the driving architecture and the control unit controls the transmission direction of the data control signal according to the indication mark on the driving devices to improve the electrical characteristics and cost-effectiveness.

Another object of the present invention is to provide a driving architecture for LCD, wherein pass lines are disposed on the transmission units to decrease the occupied region of the circuit of driving devices and increase cost-effectiveness.

According to the above objects, the present invention sets forth a driving architecture for LCD. The driving architecture mainly includes control unit, a gate driving module and data driving module. The control unit generates a gate control signal and a data control signal. The display region is disposed on the LCD panel and includes a plurality of gate lines and a plurality of data lines for displaying images on the display region. The gate driving module is electrically coupled to the control unit and display region for generating a scanning signal according to the gate control signal and driving the gate lines of the display region.

The data driving module is electrically coupled to the control unit and display region for generating a data driving signal according to the data control signal a driving the data lines corresponding to the gate lines. The data driving module includes a plurality of driving devices having at least two type of driving devices. Preferably, the data driving module has two type of driving devices, including a plurality of first-type driving devices and a plurality of second-type driving devices. Each first-type driving devices has a first indication mark and the second-type driving devices each has a second indication mark. The first indication mark indicates a first transmission direction when the data control signal passes through the first-type driving devices, and the second indication mark indicates a second transmission direction when the data control signal passes through the second-type driving devices. Based on the first indication marks and the second indication mark, the control unit generates the first transmission direction and the second transmission direction. In one embodiment, the first-type driving devices and the second-type driving devices may be source driver chips. The first-type driving devices and the second-type driving devices are disposed on the display region. The control unit transmits the data control signal via one of the first-type driving devices and one of the second-type driving devices to the rest of the first-type driving devices and the rest of the second-type driving devices.

The driving architecture of the present invention is suitable for a small scale or large scale LCD. The driving architecture mainly includes control unit, a gate driving module and data driving module. The control unit generates a gate control signal. The display region is disposed on the LCD panel and includes a plurality of gate lines and a plurality of data lines for displaying images on the display region. The gate driving module is electrically coupled to the control unit and display region for generating a scanning signal according to the gate control signal and driving the gate lines of the display region.

The data driving module is electrically coupled to the control unit and display region for generating a data driving signal according to the data control signal a driving the data lines corresponding to the gate lines. The data driving module includes a plurality of driving devices having at least two type of driving devices. Preferably, the data driving module has two type of driving devices, including a plurality of first-type transmission units and a plurality of second-type transmission units which are different from the first-type transmission units. The difference between the first-type transmission units and the second-type transmission units is pass lines disposed on the first-type transmission units. The first-type transmission units transmit the data control signal via the pass lines and further send the gate control signal via the pass lines, and the second-type transmission units transmit the data control signal. In this case, the first-type driving devices are different from or the same as the second-type driving devices. The first-type driving devices are disposed on the first-type transmission units, and the second-type driving devices are disposed on the second-type transmission units. The control units transmit the data control signal in a point-to-point way to the first-type driving devices and the second-type driving devices, respectively. Person skilled in the art should note that more than two type of transmission units can be applicable for the present invention.

For example, the first-type driving devices and the second-type driving devices are disposed on the first and second signal transmission films, respectively. The control units transmits the data control signal in a point-to-point way to the first and second signal transmission films, and the first-type driving devices on the first signal transmission films and the second-type driving devices on the second signal transmission films, respectively, outputs the processed data control signal to the display region. Meanwhile, the first signal transmission films transmit gate control signal to the gate driving module for outputting scanning signal to the gate lines of the display region. In other words, the control unit is connected to the display region via at least one of the first signal transmission films, and the control unit is connected to the display region via the second signal transmission films. Thus, the scanning signal is transmitted to the display region via the first signal transmission films for driving the gate lines, and the data control signal is transmitted to the display region via the first signal transmission films and the second signal transmission films for driving the data lines corresponding to the gate lines.

The present invention provides a driving architecture of an LCD for integrating at least two type of source drivers into a display panel, thereby improving the electrical characteristics and cost-effectiveness. In addition, the driving architecture decreases the occupying region of the circuit of driving devices, such as switch components, control circuit, and transmission/receiving circuit between the source drivers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a conventional driving architecture of an LCD wherein a source driver having bi-directional switch is used in the driving architecture;

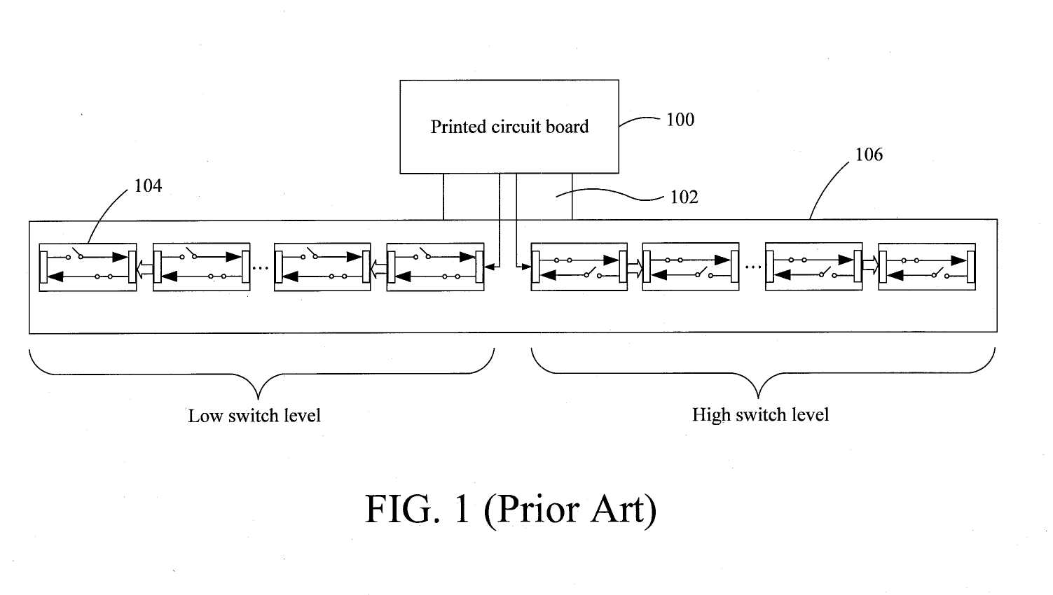

FIG. 2 is a schematic diagram of a driving architecture of an LCD according to the present invention;

FIG. 3 is a schematic diagram of a driving architecture of an LCD according to one embodiment of the present invention;

FIG. 4 is a schematic diagram of driving devices shown in FIG. 3 having different indication marks according to one embodiment of the present invention;

FIG. 5 is a schematic diagram of a driving architecture of an LCD according to another embodiment of the present invention;

FIG. 6 is a schematic diagram of driving devices shown in FIG. 5 having different indication names according to one embodiment of the present invention;

FIG. 7 is a schematic diagram of a driving architecture suitable for a small scale LCD, according to one embodiment of the present invention; and

FIG. 8 is a schematic diagram of a driving architecture suitable for a large scale LCD, according to one embodiment of the present invention.

### DETAILED DESCRIPTION OF THE PREFERRED EMBODIMENTS

The present invention provides a driving architecture of an LCD. A plurality of different type of driving devices are installed on the substrate of the driving architecture so that the control unit is capable of controlling the transmission direction of the data control signal via the indication marks of the driving devices. Thus, the electrical characteristics are improved. Different type of pass lines are used for different transmission units to decrease the occupied region of the circuit of driving devices and increase cost-effectiveness. The driving architecture of the present invention is suitable for LCD.

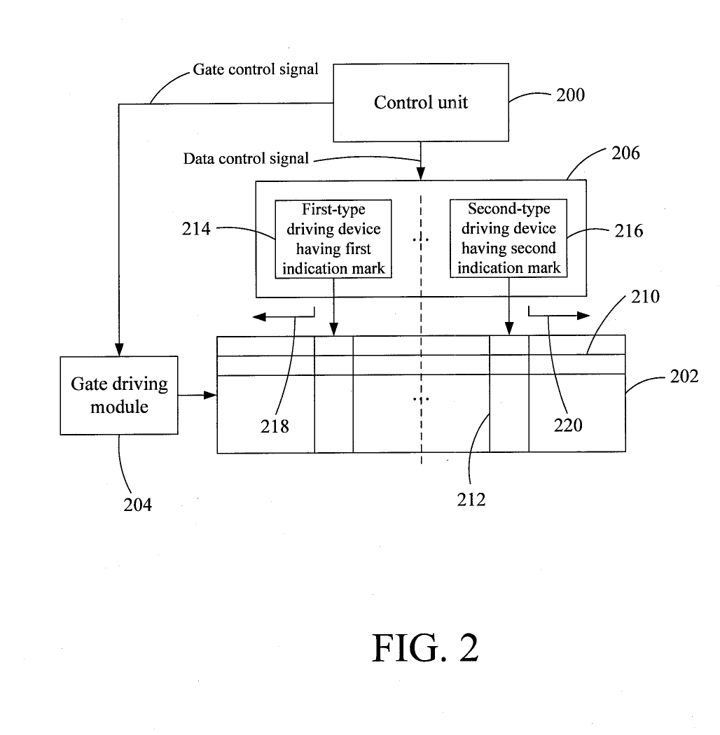

FIG. 2 is a schematic diagram of a driving architecture of an LCD according to the present invention. The driving architecture mainly includes a control unit 200, a gate driving module 204 and a data driving module 206. The control unit 200 generates a gate control signal and a data control signal. For example, the control unit 200 is a timing controller for controlling the output timing of the gate control signal and the data control signal. The display region 202 is disposed on the LCD panel (not shown) and includes a plurality of gate lines 210 and a plurality of data lines 212 for displaying images on the display region 202. The gate driving module 204 is electrically coupled to the control unit 200 and display region 202 for generating a scanning signal according to the gate control signal and driving the gate lines 210 of the display region 202.

The data driving module 206 is electrically coupled to the control unit 200 and display region 202 for generating a data driving signal according to the data control signal a driving the data lines 212 corresponding to the gate lines 210. The data driving module 206 includes a plurality of driving devices having at least two type of driving devices. Preferably, the data driving module 206 has two type of driving devices, including a plurality of first-type driving devices 214 and a plurality of second-type driving devices 216. Each first-type driving devices has a first indication mark and the second-type driving devices each has a second indication mark. The first indication mark indicates a first transmission direction 218 when the data control signal passes through the first-type driving devices 214, and the second indication mark indicates a second transmission direction 220 when the data control signal passes through the second-type driving devices 216. That is, the data control signal is transmitted according to the first transmission direction 218 and the second transmission direction 220.

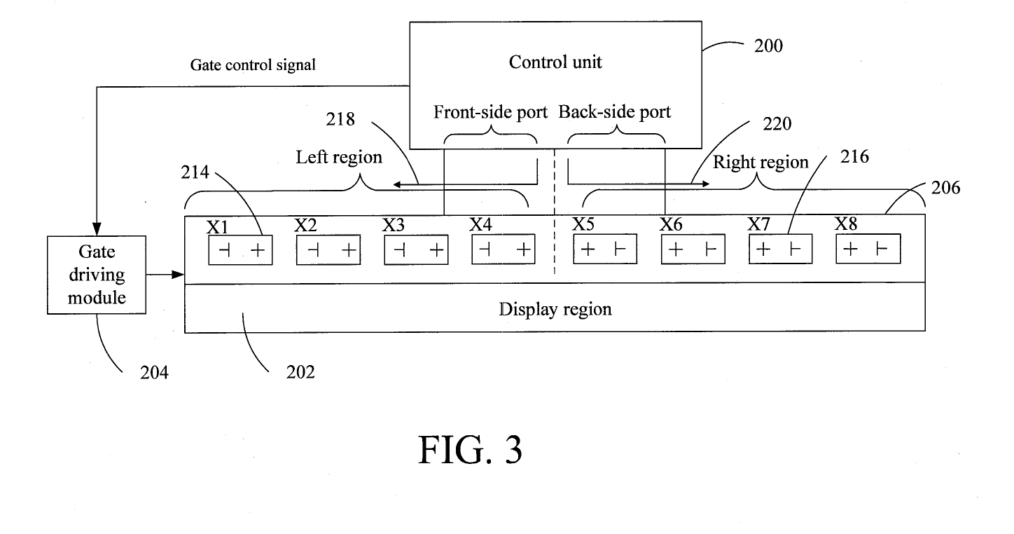

FIG. 3 is a schematic diagram of a driving architecture of an LCD according to one embodiment of the present invention. The driving architecture mainly includes a control unit 200, a gate driving module 204 and a data driving module 206. The control unit 200 generates a gate control signal and two sets of data control signals passed through the front-side port and the back-side port. The display region 202 is disposed on the LCD panel (not shown) and includes a plurality of gate lines 210 and a plurality of data lines 212 for displaying images on the display region 202. The gate driving module 204 is electrically coupled to the control unit 200 and display region 202 for generating a scanning signal according to the gate control signal and driving the gate lines 210 of the display region 202.

The data driving module 206 is electrically coupled to the control unit 200 and the display region 202 for generating a data driving signal according to the data control signal a driving the data lines 212 corresponding to the gate lines 210. The data driving module 206 includes a plurality of driving devices having at least two types of driving devices. Preferably, the data driving module 206 has two types of driving devices, including a plurality of first-type driving devices 214, such as driving chips X1 through X4, and a plurality of second-type driving devices 216, such as driving chips X5 through X8. Each first-type driving device 214 has a first indication mark and each second-type driving devices 216 has a second indication mark. The first indication mark indicates a first transmission direction 218 when the data control signal passes through the first-type driving devices 214, and the second indication mark indicates a second transmission direction 220 when the data control signal passes through the second-type driving devices 216. Based on the first indication marks and the second indication mark, the control unit 200 generates the first transmission direction 218 and the second transmission direction 220. Preferably, the first transmission direction 218 is opposite to the second transmission direction 220 so that the data control signal is transmitted according to the first transmission direction 218 and the second transmission direction 220. In one embodiment, the first-type driving devices 214 and the second-type driving devices 216 may be source driver chips. The first-type driving devices 214 and the second-type driving devices 216 are disposed on the display region 202. For example, the first-type driving devices 214 and the second-type driving devices 216 are disposed on the substrate, such as glass substrate, of the display region 202, which is defined as chip-on-glass (COG).

In one preferred embodiment, the first-type driving devices 214 (X1 through X4) are series of connections, and the second-type driving devices 216 are also a series of connections. The control unit 200 serially transmits the data control signal from the first-type driving device (X4) 214 to the rest of the first-type driving devices (X3 through X3) 214. Similarly, the control unit 200 serially transmits the data control signal from the second-type driving device (X5) 216 to the rest of the second-type driving devices (X6 through X8) 216 wherein the second-type driving device (X5) is adjacent to the first-type driving device (X4) 214. Person skilled in the art should note that more than two type of driving devices can be applicable for the present invention and the control unit transmits the data control signal via one of the first-type driving devices (X1 through X3) 214 and one of the second-type driving devices (X6 through X8) 216.

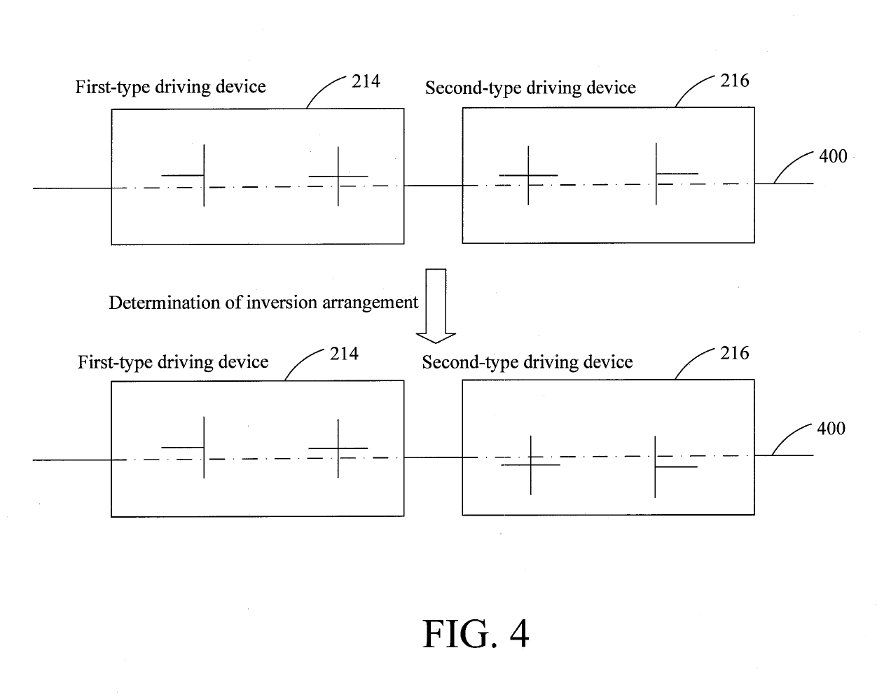

FIG. 4 is a schematic diagram of driving devices shown in FIG. 3 having different indication marks according to one embodiment of the present invention. The first-type driving devices 214 and the second-type driving devices 216 further include alignment marks 400, such as central line. The first indication marks on the first-type driving devices 214 are aligned to the second indication marks on the second-type driving devices 216 according to the alignment marks 400. Therefore, the first transmission directions of the data control signal of the first-type driving devices 214 are identical, and the second transmission directions of the data control signal of the second-type driving devices 216 are identical. When the first indication marks and the second indication marks offset from the alignment marks, such as the first indication marks are opposite to the second indication marks in view of the central line, the data control signal passed through the first-type driving devices 214 and the second-type driving devices 216 is determined whether the first transmission direction 218 and the second transmission direction 220 or not.

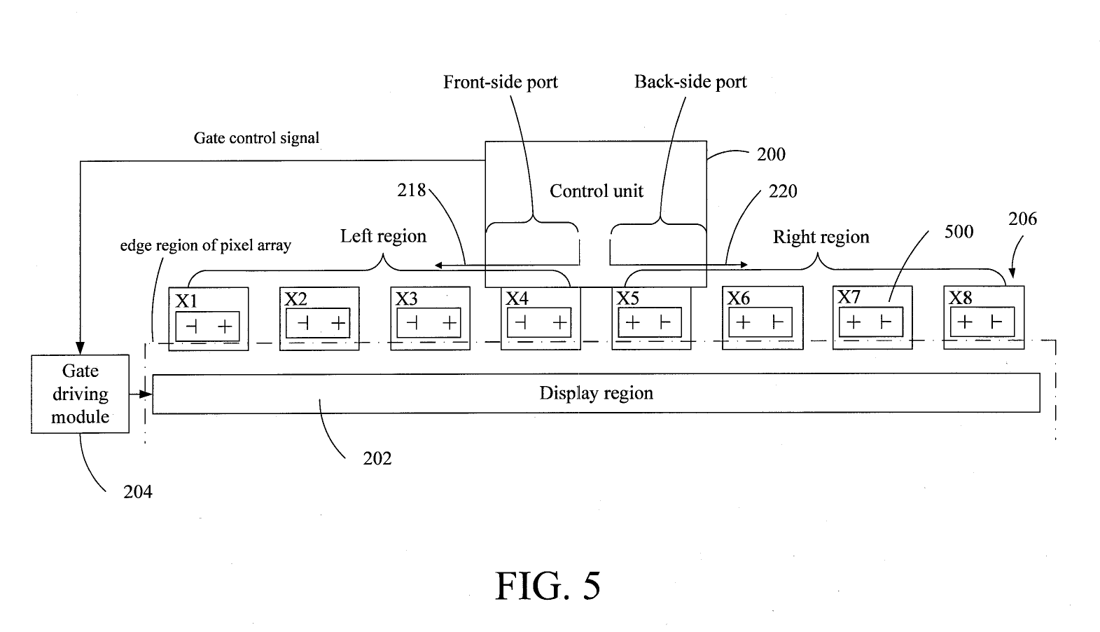

FIG. 5 is a schematic diagram of a driving architecture of an LCD according to another embodiment of the present invention. The driving architecture mainly includes a control unit 200, a gate driving module 204 and a data driving module 206. The control unit 200 generates a gate control signal and two sets of data control signals passed through the front-side port and the back-side port. The display region 202 is disposed on the LCD panel (not shown) and includes a plurality of gate lines 210 and a plurality of data lines 212 for displaying images on the display region 202. The gate driving module 204 is electrically coupled to the control unit 200 and display region 202 for generating a scanning signal according to the gate control signal and driving the gate lines 210 of the display region 202.

The data driving module 206 is electrically coupled to the control unit 200 and display region 202 for generating a data driving signal according to the data lines 212 corresponding to the gate lines 210. In one embodiment, the first-type driving devices 214 and the second-type driving devices 216 are disposed on the signal transmission material 500, such as transmission film, which is defined as chip-on-film (COF) or tape automated bonding (TAB). The signal transmission material 500 is bonded onto the edge region of pixel array of the LCD.

Preferably, the data driving module 206 has two types of driving devices, including a plurality of first-type driving devices 214, such as driving chips X1 through X4, and a plurality of second-type driving devices 216, such as driving chips X5 through X8. The first indication mark indicates a first transmission direction 218 when the data control signal passes through the first-type driving devices 214, and the second indication mark indicates a second transmission direction 220 when the data control signal passes through the second-type driving devices 216. Based on the first indication mark and the second indication mark, the control unit 200 generates the first transmission direction 218 and the second transmission direction 220. Preferably, the first transmission direction 218 is opposite to the second transmission direction 220.

In one preferred embodiment, the first-type driving devices 214 (X1 through X4) are series connections by electrically connecting the signal transmission material 500 thereon, and the second-type driving devices 216 are series connections by electrically connecting the signal transmission material 500 thereon. The control unit 200 serially transmits the data control signal from the first-type driving device (X4) 214 to the rest of the first-type driving devices (X3 through X3) 214. Similarly, the control unit 200 serially transmits the data control signal from the second-type driving device (X5) 216 to the rest of the second-type driving devices (X6 through X8) 216 wherein the second-type driving device (X5) is adjacent to the first-type driving device (X4) 214.

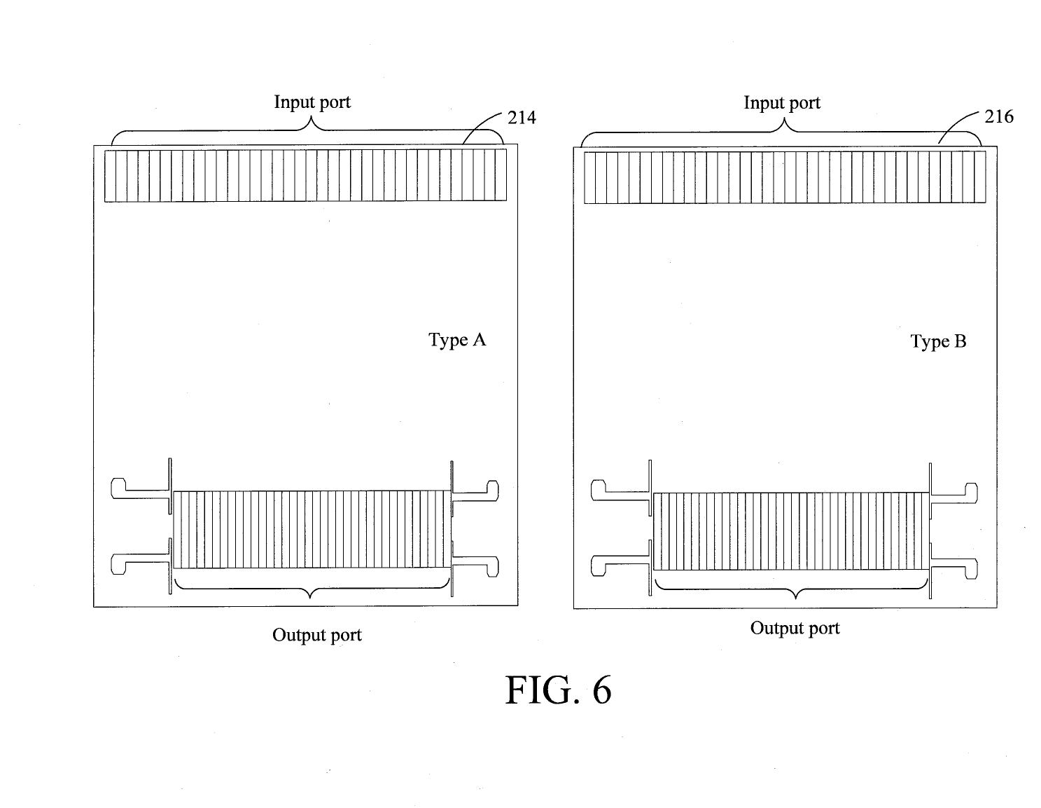

FIG. 6 is a schematic diagram of driving devices shown in FIG. 5 having different indication names according to one embodiment of the present invention. The first indication marks of the first-type driving devices 214 are represented as indication names, such as type A, and the second indication marks of the second-type driving devices 216 are represented as indication names, such as type B. The first-type driving devices 214 receives the data control signal from the control unit 200 and outputs the processed data control signal to the data lines of display region 202. By the same token, the second-type driving devices 216 receives the data control signal from the control unit 200 and outputs the processed data control signal to the data lines of display region 202. In one embodiment, an image device is used to determine whether the driving devices has indication marks or indication names for identifying the different type of driving devices in the data driving module.

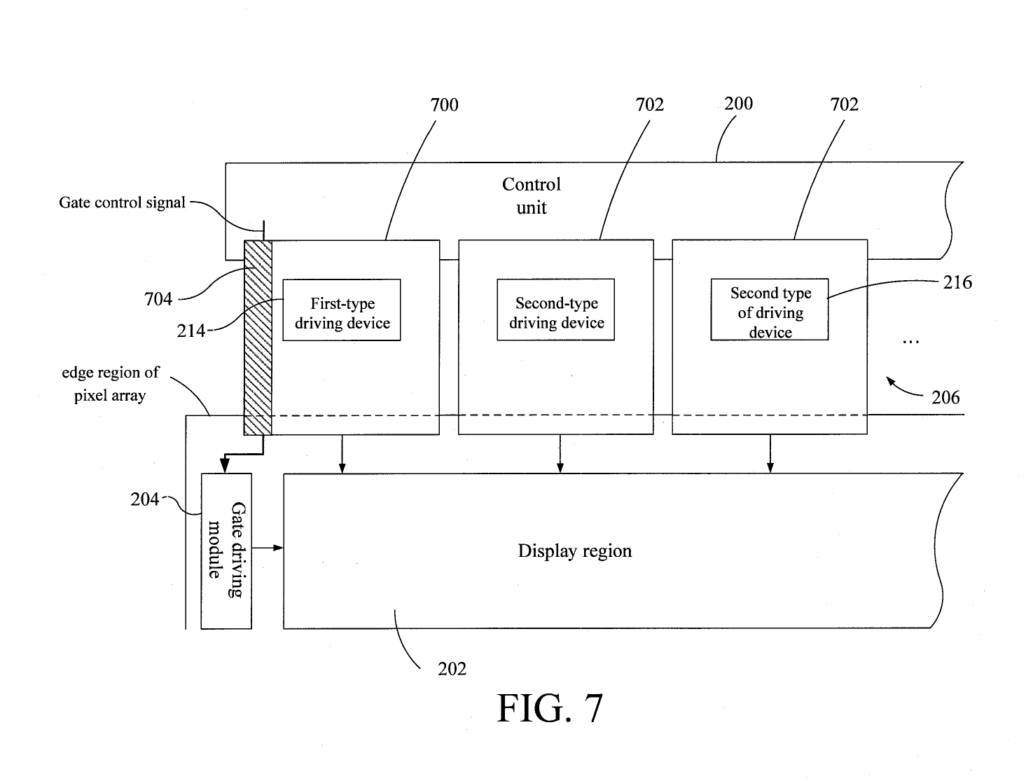

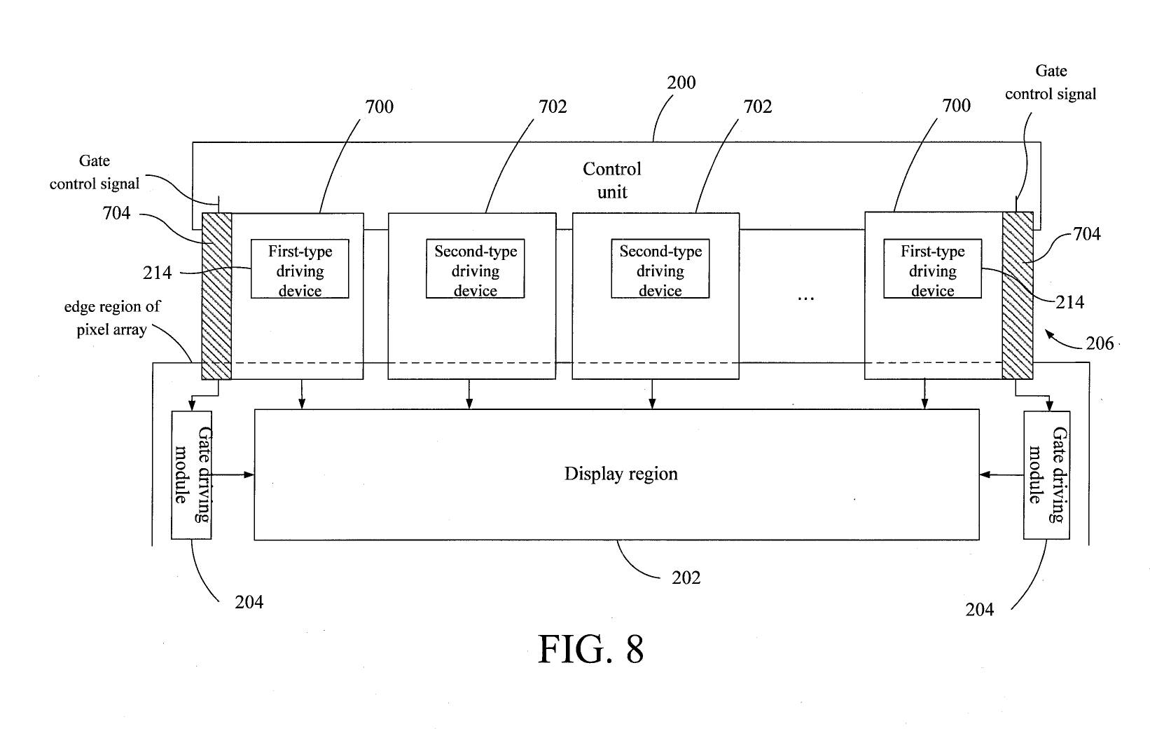

FIG. 7 is a schematic diagram of a driving architecture suitable for a small scale LCD according to one embodiment of the present invention. FIG. 8 is a schematic diagram of a driving architecture suitable for a large scale LCD according to one embodiment of the present invention. The driving architecture mainly includes a control unit 200, a gate driving module 204 and a data driving module 206. The control unit 200 generates a gate control signal and two sets of data control signals passed through the front-side port and the back-side port. The display region 202 is disposed on the LCD panel (not shown) and includes a plurality of gate lines 210 and a plurality of data lines 212 for displaying images on the display region 202. The gate driving module 204 is electrically coupled to the control unit 200 and the display region 202 for generating a scanning signal according to the gate control signal and driving the gate lines 210 of the display region 202.

The data driving module 206 is electrically coupled to the control unit 200 and the display region 202 for generating a data driving signal according to the data control signal a driving the data lines 212 corresponding to the gate lines 210. The data driving module 206 includes a plurality of driving devices having at least two type of driving devices. Preferably, the data driving module 206 has two types of driving devices, including a plurality of first-type transmission units 700 and a plurality of second-type transmission units 702 which are different from the first-type transmission units 700. The difference between the first-type transmission units 700 and the second-type transmission units 702 is pass lines 704 disposed on the first-type transmission units 700. The first-type transmission units 700 transmit the data control signal via the pass lines 704 and further send the gate control signal via the pass lines 704, and the second-type transmission units 702 transmit the data control signal. In this case, the first-type driving devices 214 are different from or the same as the second-type driving devices 216. The first-type driving devices 214 are disposed on the first-type transmission units 700, and the second-type driving devices 216 are disposed on the second-type transmission units 702. The control unit 200 transmits the data control signal in a point-to-point way to the first-type driving devices 214 and the second-type driving devices 216, respectively. Person skilled in the art should be noted that more than two types of transmission units can be applicable for the present invention.

For example, the first-type driving devices 214 and the second-type driving devices 216 are disposed on the first and second signal transmission films (700, 702), respectively. The control units 200 transmits the data control signal in a point-to-point way to the first and second signal transmission films (700, 702), and the first-type driving devices 214 on the first signal transmission films 700 and the second-type driving devices 216 on the second signal transmission films 702, respectively, outputs the processed data control signal to the display region. Meanwhile, the first signal transmission films 700 transmit gate control signal to the gate driving module for outputting scanning signal to the gate lines of the display region. In other words, the control unit 200 is connected to the display region via at least one of the first signal transmission films 700, and the control unit 200 is connected to the display region via the second signal transmission films 702. Thus, the scanning signal is transmitted to the display region via the first signal transmission films 700 for driving the gate lines, and the data control signal is transmitted to the display region via the first signal transmission films 700 and the second signal transmission films 702 for driving the data lines corresponding to the gate lines. For example, transmission films (700, 702) include a flexible printed circuit (FPC) or transmission circuit films.

The present invention provides a driving architecture of an LCD for integrating at least two types of source drivers into a display panel, thereby improving the electrical characteristics and cost-effectiveness. In addition, the driving architecture decreases the occupied region of the circuit of driving devices, such as switch components, control circuit, and transmission/receiving circuit between the source drivers.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A driving architecture of a liquid crystal display (LCD), the driving architecture comprising:
a control unit for generating a gate control signal and a data control signal;
a gate driving module, electrically coupled to the control unit, for generating a scanning signal according to the gate control signal; and
a data driving module electrically coupled to the control unit and having a plurality of driving devices, for generating a data driving signal according to the data control signal, wherein the driving devices comprises a plurality of different type of driving devices.

2. The driving architecture of claim 1, wherein the driving devices comprises a plurality of first-type driving devices having a first indication mark, and a plurality of second-type driving devices having a second indication mark.

3. The driving architecture of claim 2, wherein the first-type driving devices and the second-type driving devices are respectively serial connected.

4. The driving architecture of claim 3, wherein the driving devices further comprises a plurality of alignment marks.

5. The driving architecture of claim 2, wherein the first indication marks of the first-type driving devices are the indication names of the first-type driving devices.

6. The driving architecture of claim 2, wherein the second indication marks of the second-type driving devices are the indication names of the second-type driving devices.

7. The driving architecture of claim 1, wherein the data driving module further comprises a plurality of first transmission units and a plurality of second transmission units, and the driving devices are disposed on the first transmission units and the second transmission units, wherein at least one of the first transmission units comprises a transmission region so that the control unit transmits the gate control signal to the gate driving module via the transmission region, and the data control signal is transmitted to the driving devices via the first transmission units and the second transmission units.

8. A driving architecture for use in a liquid crystal display (LCD), the driving architecture comprising:
a control unit for generating a gate control signal and a data control signal;
a gate driving module, electrically coupled to the control unit, for generating a scanning signal according to the gate control signal; and
a data driving module electrically coupled to the control unit and having a plurality of driving devices, for generating a data driving signal according to the data control signal, wherein each of the driving devices has an indication mark and at least one of the driving devices has a transmission region so that the control unit transmits the data control signal to the data driving module according to the indication mark of each of the driving devices, and the control unit transmits the gate control signal to the gate driving module via the transmission region.

9. The driving architecture of claim 8, wherein the driving devices comprises a plurality of first-type driving devices having a first indication mark, and a plurality of second-type driving devices having a second indication mark.

10. The driving architecture of claim 9, wherein the first-type and the second-type driving devices are respectively serial connected.

11. The driving architecture of according to claim 10, wherein the driving devices further comprises a plurality of alignment marks.

12. The driving architecture of claim 9, wherein the first indication marks of the first-type driving devices are the indication names of the first-type driving devices.

13. The driving architecture of claim 9, wherein the second indication marks of the second-type driving devices are the indication names of the second-type driving devices.

14. The driving architecture of claim 8, wherein the data driving module further comprises a plurality of first transmission units and a plurality of second transmission units, and the driving devices are disposed on the first transmission units and the second transmission units, wherein at least one of the first transmission units comprises a transmission region so that the control unit transmits the gate control signal to the gate driving module via the transmission region, and the data control signal is transmitted to the driving devices via the first transmission units and the second transmission units.
